(19) United States
(12) Patent Application Publication
(10) Pub. No.: US 2022/0410192 A1
(43) Pub. Date: Dec. 29, 2022

(54) HOLDING MEMBER, UNMANNED AERIAL VEHICLE, AND SPRAYING METHOD

(71) Applicant: Toyo Seikan Co., Ltd., Tokyo (JP)

(72) Inventors: Atsushi KOMINAMI, Kanagawa (JP); Souji ARAKI, Kanagawa (JP); Hiroki TANAKA, Kanagawa (JP)

(21) Appl. No.: 17/801,267

(22) PCT Filed: Feb. 16, 2021
(86) PCT No.: PCT/JP2021/005773

§ 371 Date: Aug. 22, 2022

(30) Foreign Application Priority Data
Feb. 28, 2020 (JP) 2020-034282

(51) Int. Cl. B05B 11/04; B05B 15/62; B05B 15/68; B05B 12/08; B64C 39/02; B64D 1/18

(52) U.S. Cl. CPC B05B 11/048; B05B 15/62; B05B 15/68; B05B 12/081; B64C 39/024; B64D 1/18; B64C 2201/128; B64C 2201/127; B64C 2201/108; A01M 7/00

(57) ABSTRACT

There is provided a holding member including: a holding unit configured to hold a package with a variable volume; and a connection unit configured to connect the holding unit and an unmanned aerial vehicle. The holding member may include a posture change unit configured to change a posture of the holding member, and a posture fixing unit for the holding unit. The holding member may include a package fixing unit configured to fix the package to the holding unit. There is provided a spraying method in which in a state in which the holding member holds the package, and the holding member holding the package is mounted on the unmanned aerial vehicle, a content of the package is sprayed from the unmanned aerial vehicle.

### BACKGROUND

### 1. Technical Field

The present invention relates to a holding member, an unmanned aerial vehicle, and a spraying method.

### 2. Related Art

In the related art, an unmanned aerial vehicle on which a container is mounted is known (for example, refer to Patent Document 1).
Patent Document 1: Japanese Translation Publication of a PCT Route Patent Application No. 2018-516197

### Technical Problem

With the unmanned aerial vehicles in the related art, it may be difficult to handle the container.

### GENERAL DISCLOSURE

A first aspect of the present invention provides a holding member including: a holding unit configured to hold a package with a variable volume; and a connection unit configured to connect the holding unit and an unmanned aerial vehicle.

A second aspect of the present invention provides a spraying method in which in a state in which the holding member according to the first aspect of the present invention holds the package, and the holding member holding the package is mounted on the unmanned aerial vehicle, a content of the package is sprayed from the unmanned aerial vehicle.

The summary clause does not necessarily describe all necessary features of the embodiments of the present invention. The present invention may also be a sub-combination of the features described above.

### BRIEF DESCRIPTION OF THE DRAWINGS

FIG. 1 shows an example of an unmanned aerial vehicle 100.

FIG. 2A shows an example of a package 40.

FIG. 2B shows an example of the package 40.

FIG. 3A shows an example of a method for attaching the package 40 to a holding unit 110.

FIG. 3B shows an example of a method for changing a posture of the holding unit 110.

FIG. 3C shows an example of a method for fixing the posture of the holding unit 110.

FIG. 4A is an example of the unmanned aerial vehicle 100 on which a holding member 200 is mounted.

FIG. 4B shows an example of an opening and closing operation by the holding unit 110.

FIG. 5A shows an example of a configuration of the unmanned aerial vehicle 100.

FIG. 5B shows an example of a configuration of a package fixing unit 113.

FIG. 6A shows an example of the configuration of the unmanned aerial vehicle 100.

FIG. 6B shows an example of a method for replacing the package 40.

FIG. 7A shows an example of the configuration of the unmanned aerial vehicle 100.

FIG. 7B shows an example of a configuration of the holding unit 110.

FIG. 7C shows an example of a specific configuration of a sealing mechanism 180.

FIG. 8A shows an example of the configuration of the holding unit 110 having an opening 118.

FIG. 8B shows an example of the configuration of the holding unit 110 having the opening 118.

FIG. 9A shows an example of the configuration of the holding unit 110 having a determination unit 150.

FIG. 9B shows an example of the holding unit 110 having a detection unit 152.

FIG. 10A shows an example of the configuration of a holding unit 110 having a housing member 160.

FIG. 10B shows an example of the configuration of the holding unit 110 having the housing member 160.

FIG. 11 shows an example of the holding unit 110 that holds a plurality of packages 40.

FIG. 12 shows an example of a method for connecting the plurality of packages 40.

FIG. 13 shows an example of a spraying method by using the unmanned aerial vehicle 100.

FIG. 14 shows an example of a steering system 400 of the unmanned aerial vehicle 100.

FIG. 15 shows an example of an operation flowchart of a method for spraying a content 46.

### DESCRIPTION OF EXEMPLARY EMBODIMENTS

Hereinafter, the invention will be described through embodiments of the invention, but the following embodiments do not limit the invention according to claims. In addition, not all the combinations of features described in the embodiments are essential for means to solve the problem in the invention.

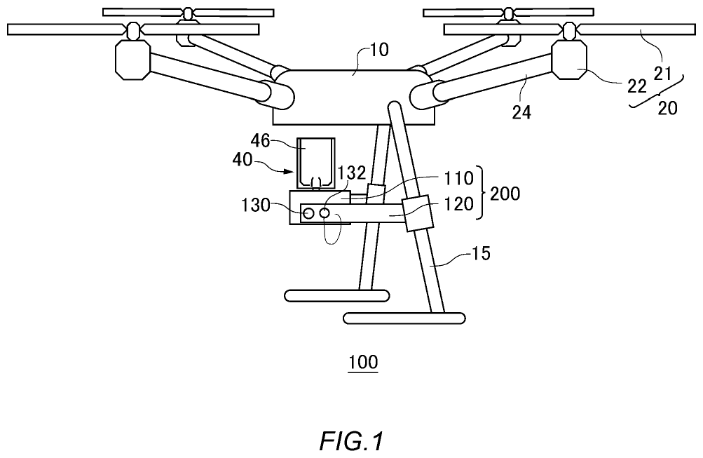

FIG. 1 shows an example of an unmanned aerial vehicle 100. The unmanned aerial vehicle 100 of the present example includes a main body unit 10, a leg unit 15, a propulsion unit 20, an arm unit 24, and a holding member 200. The holding member 200 is configured to hold a package 40.

The unmanned aerial vehicle 100 is a flying object that flies in the air. The unmanned aerial vehicle 100 sprays a content 46 contained in the package 40.

The main body unit 10 stores various control circuits, a power supply, and the like of the unmanned aerial vehicle 100. In addition, the main body unit 10 may function as a structure body for connecting configurations to each other in the unmanned aerial vehicle 100. The main body unit 10 of the present example is connected to the propulsion unit 20 by the arm unit 24.

The propulsion unit 20 generates a propulsive force for propelling the unmanned aerial vehicle 100. The propulsion unit 20 has a rotor wing 21 and a rotation drive unit 22. The unmanned aerial vehicle 100 of the present example includes four propulsion units 20. The propulsion unit 20 is attached to the main body unit 10 via the arm unit 24. It should be noted that the unmanned aerial vehicle 100 may be a flying object having a fixed wing as the propulsion unit 20.

The rotor wing 21 generates a propulsive force by a rotation. Four rotor wings 21 are provided around the main body unit 10; however, a method for arranging the rotor wings 21 is not limited to the present example. The rotor wing 21 is provided at a tip of the arm unit 24 via the rotation drive unit 22.

The rotation drive unit 22 has a power source such as a motor and drives the rotor wing 21. The rotation drive unit 22 may have a brake mechanism for the rotor wing 21. The rotor wing 21 and the rotation drive unit 22 may be directly attached to the main body unit 10 by omitting the arm unit 24.

The arm unit 24 is provided to extend radially from the main body unit 10. The unmanned aerial vehicle 100 of the present example includes four arm units 24 provided corresponding to the four propulsion units 20. The arm unit 24 may be fixed or movable. Another component such as a camera may be fixed to the arm unit 24.

The leg unit 15 is connected to the main body unit 10 and holds a posture of the unmanned aerial vehicle 100 at a time of landing. The leg unit 15 holds the posture of the unmanned aerial vehicle 100 in a state in which the propulsion unit 20 is stopped. The unmanned aerial vehicle 100 of the present example has two leg units 15; however, the present invention is not limited to this. The holding member 200 is attached to the leg unit 15.

The holding member 200 includes a holding unit 110 and a connection unit 120. It should be noted that the holding member 200 of the present example includes a posture change unit 130 and a posture fixing unit 132. The posture change unit 130 and the posture fixing unit 132 will be described below.

The holding unit 110 is configured to hold the package 40 with a variable volume. The holding unit 110 is connected to the unmanned aerial vehicle 100 via the connection unit 120. A material of the holding unit 110 is not particularly limited as long as it is possible to hold the package 40. In an example, the material of the holding unit 110 includes metal such as aluminum, plastic, or a lightweight material which has a high strength such as carbon fiber. In addition, the material of the holding unit 110 is not limited to a hard material, and may include a soft material, for example, a rubber material such as silicone rubber or urethane foam. It should be noted that the holding unit 110 may include a temperature control mechanism for heating or cooling the package 40, or maintaining a temperature of the package 40.

The connection unit 120 is configured to connect the holding unit 110 and the unmanned aerial vehicle 100. The connection unit 120 of the present example connects the holding unit 110 to the leg unit 15. The connection unit 120 may connect the holding unit 110 of the main body unit 10 or the arm unit 24 or the like. The connection unit 120 may be fixed or movable. The connection unit 120 may be a gimbal for controlling a position of the holding member 200 in three axis directions. The connection unit 120 may be controlled according to a direction of spraying the content 46 of the package 40.

The package 40 contains the content 46. A volume of the package 40 changes according to a remaining amount of the content 46. The package 40 is held by the holding member 200, and thus may not be self-supporting. The package 40 is held by the holding member 200, and thus may be a flexible package that is lighter and more deformable in comparison with a rigid container of which a material includes a polyethylene material, a metal material, or the like. In this way, it is not necessary for a container, which directly touches the content 46, to be made of a rigid material, and thus the package 40 can be folded when the package 40 is in an empty state. Thereby, removing and carrying from the unmanned aerial vehicle 100 is easy. In addition, when the disposable package 40 is used, cleaning work of the container is unnecessary, and a trouble of replacing the content 46 is reduced.

The content 46 may be any of a liquid, a gas, or a solid. The content 46 may be in any state of a powdery, granular, or gel shape, or the like. For example, the content 46 is an agrochemical which is sprayed by the unmanned aerial vehicle 100. By containing the content 46 in the package 40, the agrochemical can be more safely handled in comparison with a case where the agrochemical is directly replaced in the container. The content 46 may be poured out from the package 40 by gravity, pressurization of the package 40, or suction by a pump.

The unmanned aerial vehicle 100 of the present example moves to a location where spraying of agrochemicals is required, and sprays the content 46. On the unmanned aerial vehicle 100, the package 40 can be mounted in accordance with a necessary amount of agrochemicals. Therefore, a body of the unmanned aerial vehicle 100 can be more simplified in comparison with a case where a large container is used.

For example, in the unmanned aerial vehicle 100 of the present example, when the content 46 with a small volume is required, it is not necessary to mount a container with a large capacity. In addition, even when the content 46 with a large volume is contained, a fluctuation of a residual liquid of the content 46 is reduced, and thus a flight control of the unmanned aerial vehicle 100 is easy. Even after the content 46 is used up, replacement work of the package 40 is easy. In addition, when the package 40 is disposable, the cleaning work of the container is unnecessary. The package 40 can be folded, and thus it is easy to carry a plurality of packages 40.

It should be noted that the unmanned aerial vehicle 100 may be provided with a camera for capturing images of surroundings. The camera of the unmanned aerial vehicle 100 may be a fixed camera or a movable camera. In an example, the camera is attached to a side surface of the main body unit 10. The camera may be attached to a portion, such as the leg unit 15, other than the main body unit 10. A user of the unmanned aerial vehicle 100 can operate the unmanned aerial vehicle 100 based on a video captured by the camera. In addition, the user of the unmanned aerial vehicle 100 may directly see and steer the unmanned aerial vehicle 100.

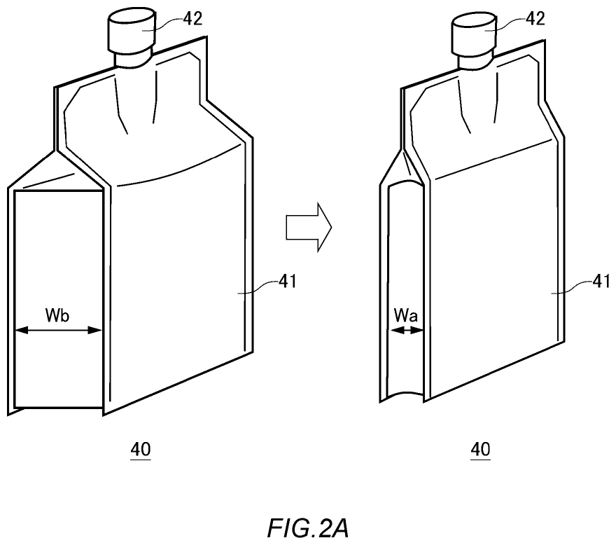

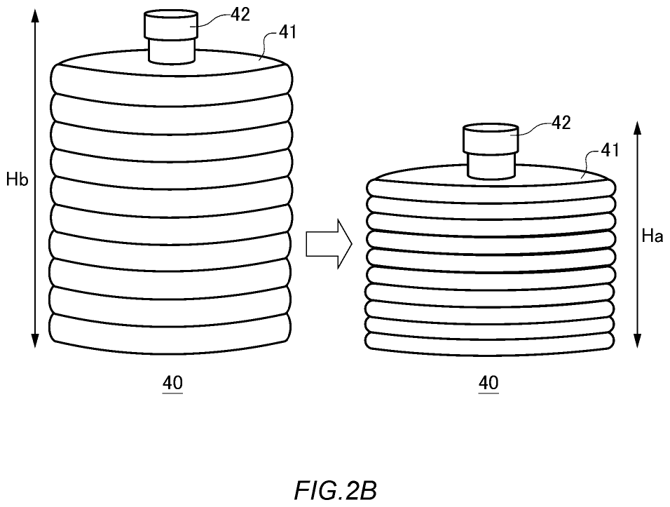

FIG. 2A shows an example of a package 40. The package 40 of the present example is a pouch type package including a main body 41 and a pouring portion 42. For example, the package 40 is a bag made of resin.

The main body 41 can contain the content 46 for a capacity to be reduced as the content 46 is reduced. A volume of the main body 41 of the present example changes in a width direction according to the remaining amount of the content 46. A width Wa of the main body 41 after use is smaller than a width Wb of the main body 41 before use. The volume of the main body 41 may change by a negative pressure for pouring out the content 46. A deformation direction of the main body 41 may change in the width direction by rigidity of a shape of the main body 41, may change in a direction for constraint by an external force from the holding member 200, or may change by its own weight. By placing the main body 41 flat, the width of the main body 41 easily changes by its own weight.

The pouring portion 42 is provided in the main body 41. The pouring portion 42 of the present example is provided at an upper end portion of the main body 41, but may be provided on the side surface of the main body 41. The pouring portion 42 may be provided on a surface instead of the end portion. The pouring portion 42 has an opening for pouring in or pouring out the content 46. The package 40 of the present example has one pouring portion 42, but may have a plurality of pouring portions 42. For example, the pouring portion 42 is a spout, a tube, a nozzle, or the like through which the content 46 passes. When the package 40 is not used, a cap for preventing the content 46 from being poured out may be attached to the pouring portion 42.

It should be noted that in the present example, a direction in which the content 46 is poured out from the pouring portion 42 is a longitudinal direction (or a height direction); however, the present invention is not limited to this. A direction in which the content 46 is sprayed from the pouring portion 42 may be a short direction (for example, the width direction). In addition, in the present specification, the expression of “upper” or “lower” may be used to indicate a locational relationship, but is not limited to a vertical direction.

FIG. 2B shows an example of the package 40. The package 40 of the present example is a bottle type package including the main body 41 and the pouring portion 42.

The main body 41 can contain the content 46 for a capacity to be reduced as the content 46 is reduced. The volume of the main body 41 of the present example changes in the height direction according to the remaining amount of the content 46. A height Ha of the main body 41 after use is lower than a height Hb of the main body 41 before use. The volume of the main body 41 may change by a negative pressure for pouring out the content 46. A deformation direction of the main body 41 may change in the height direction by rigidity of a shape of the main body 41, may change in a direction for constraint by an external force from the holding member 200, or may change by its own weight. By placing the main body 41 vertically, the height of the main body 41 easily changes by its own weight.

The pouring portion 42 is provided at the upper end portion of the main body 41. The package 40 of the present example has one pouring portion 42, but may be provided with the plurality of pouring portions 42. When the package 40 is not used, a cap for preventing the content 46 from being poured out may be attached to the pouring portion 42.

In this way, in the package 40, an internal volume is reduced as the content 46 is reduced, and thus it is possible to pour out the content 46 without generating an air layer inside the package 40. Therefore, in comparison with a rigid container in which the air layer is generated as the content is reduced, the residual liquid is less likely to fluctuate (that is, sloshing), and thus flight stability of the unmanned aerial vehicle 100 is enhanced.

It should be noted that in the present specification, the pouch type package 40 as shown in FIG. 2A may be used for the description. Note that in each example, the bottle type package 40 as shown in FIG. 2B may be appropriately used. A direction in which the shape and the volume of the package 40 changes is not limited to a configuration of each example. The package 40 may be, for example, made of rubber, paper, metal leaf, or by a combination of these without being limited to being made of resin.

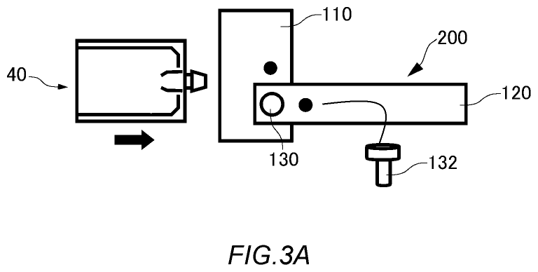

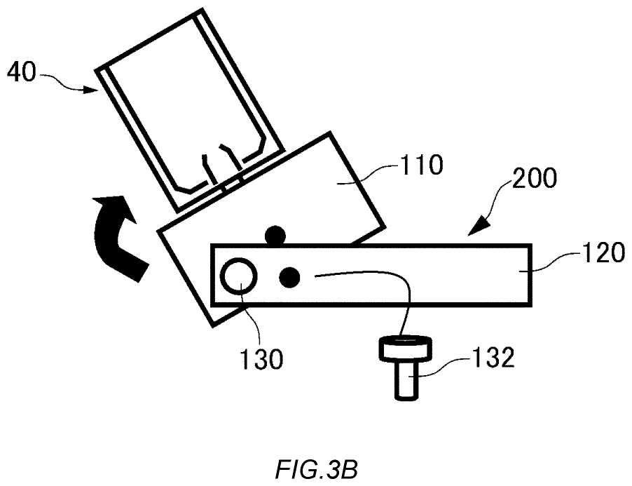

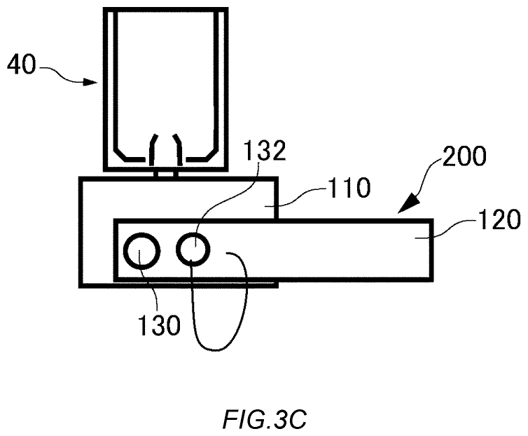

FIG. 3A shows an example of a method for attaching the package 40 to a holding unit 110. In the present example, in the unmanned aerial vehicle 100 of FIG. 1, a case where the package 40 is attached to the holding unit 110 will be described.

The posture change unit 130 is configured to change a posture of the holding unit 110. For example, the posture change unit 130 rotates the posture of the holding unit 110 by 90 degrees when the unmanned aerial vehicle 100 is in flight and when the package 40 is attached. The posture change unit 130 changes the posture of the holding unit 110 to an angle at which the package 40 is easily attached. For example, the posture change unit 130 changes the posture of the holding unit 110 such that the package 40 can be inserted in a horizontal direction.

The posture fixing unit 132 fixes the posture of the holding unit 110. The posture fixing unit 132 of the present example prohibits the posture change by fixing a drive location of the posture change unit 130. In addition, the posture fixing unit 132 permits the posture change by releasing the fixing of the drive location of the posture change unit 130. The posture fixing unit 132 of the present example fixes the posture of the holding unit 110 by inserting a pin into holes provided in the holding unit 110 and the connection unit 120. The present example shows a state in which the posture fixing unit 132 is not inserted, and the posture of the holding unit 110 is able to be changed.

FIG. 3B shows an example of a method for changing a posture of the holding unit 110. In the present example, in the unmanned aerial vehicle 100 of FIG. 1, a case where the posture of the holding unit 110 is changed will be described.

The posture change unit 130 changes the posture of the holding unit 110 by rotating the holding unit 110 in a state in which the package 40 is attached. The posture change unit 130 may electrically rotate the holding unit 110, or the user may manually rotate the holding unit 110. By changing the posture of the holding unit 110 according to a state, it is easy to replace the package 40.

FIG. 3C shows an example of a method for fixing the posture of the holding unit 110. In the present example, in the unmanned aerial vehicle 100 of FIG. 1, a case where the posture of the holding unit 110 is fixed will be described.

The posture fixing unit 132 fixes the posture of the holding unit 110 by inserting the pin into the holes of the holding unit 110 and the connection unit 120. The method for fixing the posture of the holding unit 110 by the posture fixing unit 132 is not limited to the present example. The posture fixing unit 132 may control the posture of the holding unit 110 by an electrical method rather than a mechanical method. The posture fixing unit 132 fixes the posture of the holding unit 110 such that the pouring portion 42 is oriented in a direction in which the content 46 is desired to be poured out.

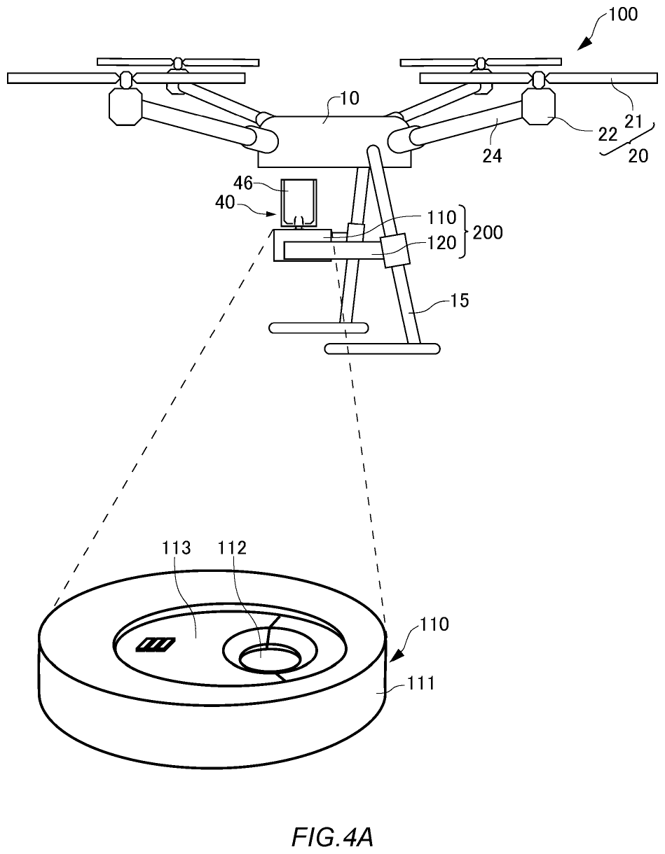

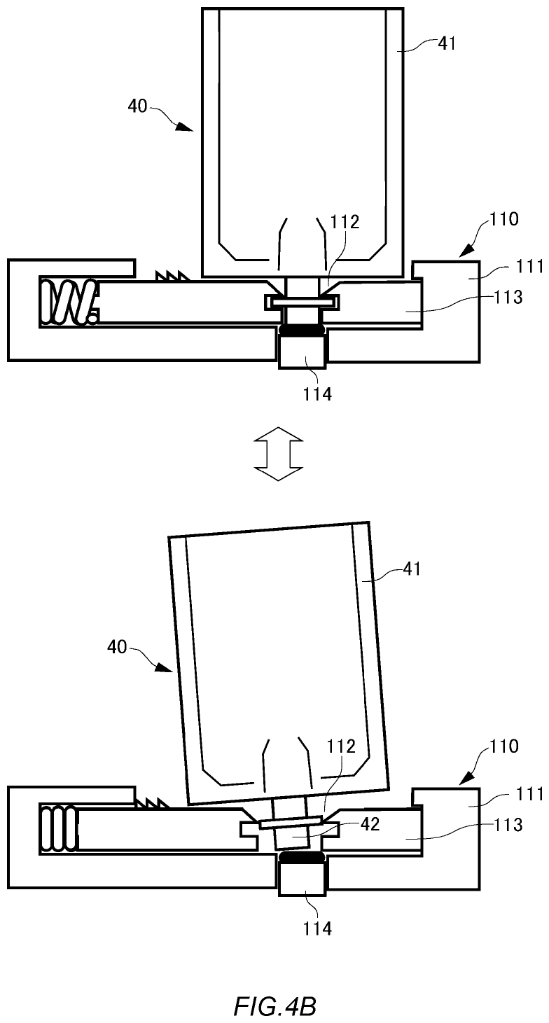

FIG. 4A is an example of the unmanned aerial vehicle 100 on which a holding member 200 is mounted. FIG. 4A shows an enlarged view of the holding unit 110. The holding unit 110 includes a main body 111 and a package fixing unit 113.

The main body 111 holds the package fixing unit 113. The main body 111 is connected to the leg unit 15 by the connection unit 120. The main body 111 of the present example has a shape of a disk; however, the present invention is not limited to this. The main body 111 has the package fixing unit 113 in the center of the disk.

The package fixing unit 113 is configured to fix the package 40 to the holding unit 110. The package fixing unit 113 of the present example fixes the pouring portion 42 to the holding unit 110; however, the present invention is not limited to this. In the package fixing unit 113, an opening 112 is formed in accordance with an outer shape of the pouring portion 42 to fix the pouring portion 42. The package fixing unit 113 has an opening and closing mechanism, and switches between fixing and not fixing the package 40. In the package fixing unit 113, the opening 112 is formed in accordance with a shape of the outer shape of the pouring portion 42 in a closed state. The package fixing unit 113 does not fix the package 40 in an open state.

FIG. 4B shows an example of an opening and closing operation by the holding unit 110. The present example shows a cross section of the opening and closing mechanism of the holding unit 110.

The package fixing unit 113 has the opening and closing mechanism for controlling opening and closing. The opening and closing mechanism only needs to be a spring or the like that is able to switch between opening and closing. The package fixing unit 113 fixes the package 40 in the closed state. The package fixing unit 113 has a protrusion and a recession in accordance with the shape of the pouring portion 42. This makes it easier to fix a position and an angle of the package 40. The package fixing unit 113 may have an inclination for guiding the pouring portion 42 to a fixing position.

A pouring out unit 114 is connected to the pouring portion 42 to pour out the content 46. The pouring out unit 114 may function as a nozzle that determines the direction in which the content 46 is sprayed. The pouring out unit 114 may be provided to extend from the main body 111. The pouring out unit 114 may guide a position of the pouring portion 42 by having a shape in accordance with the pouring portion 42.

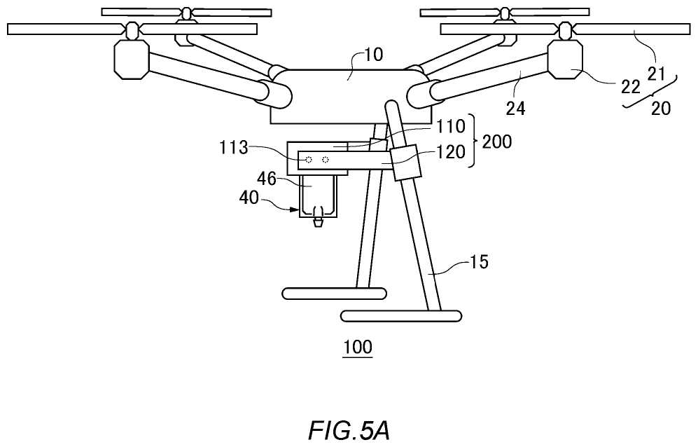

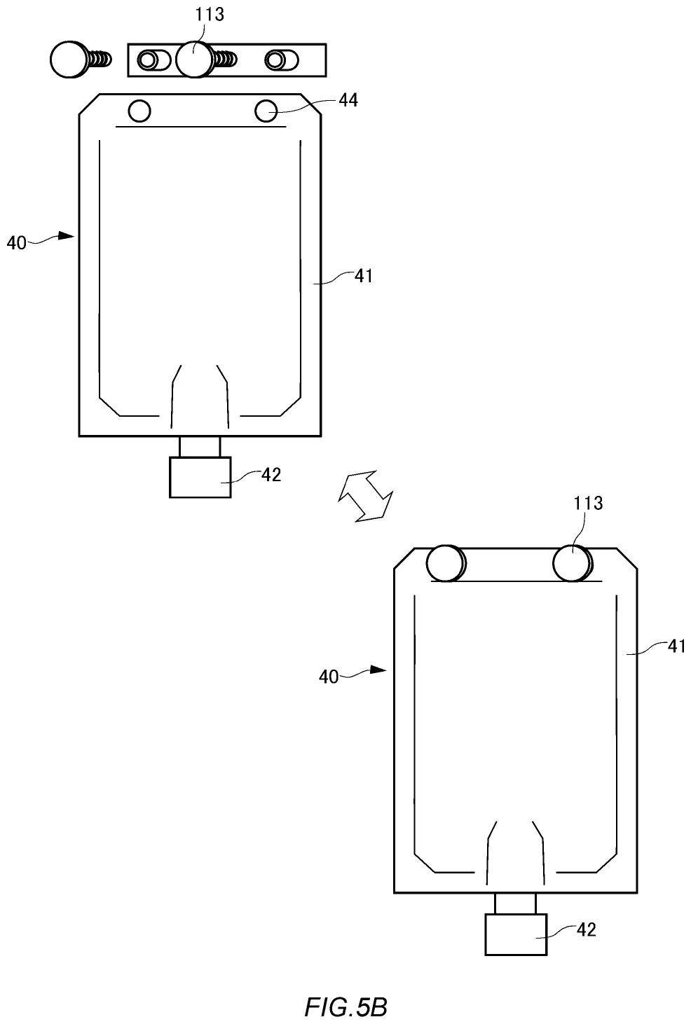

FIG. 5A shows an example of a configuration of the unmanned aerial vehicle 100. The holding unit 110 of the present example has the package fixing unit 113 configured to fix the package 40. The package fixing unit 113 is configured to fix the package 40 to the holding unit 110. The package fixing unit 113 of the present example fixes the main body 41 to the holding unit 110. The package fixing unit 113 fixes the package 40 downward; however, the present invention is not limited to this.

FIG. 5B shows an example of a configuration of a package fixing unit 113. The present example shows an enlarged view of the package fixing unit 113 of FIG. 5A.

The package fixing unit 113 is configured to fix the package 40 to the holding unit 110 by any fixing means. For example, the package fixing unit 113 fixes the package 40 by hooking to a hole of the package 40, gripping with a member of a clip shape, or adhering. The package fixing unit 113 of the present example fixes the package 40 by inserting a screw into the hole provided in the package 40. The package fixing unit 113 is fixing means capable of detaching a fixing target portion 44. The package fixing unit 113 of the present example fixes the main body 41 at two locations, but may fix the main body 41 at one location or three or more locations.

The fixing target portion 44 is fixed to the holding unit 110 by the package fixing unit 113. The fixing target portion 44 of the present example is a hole provided in the main body 41. The fixing target portion 44 may be a portion which is fixed to the holding unit 110 by a magnet, or may be a portion which is fixed to the holding unit 110 by an adhesive tape. In this way, the fixing target portion 44 may be a portion which is directly fixed by the holding unit 110, or may be a portion, such as a hole, which is used for fixing the position by the holding unit 110. The fixing target portion 44 is provided in two locations on the main body 41.

It should be noted that the holding member 200 may fix the pouring portion 42 in addition to the main body 41. For example, the holding member 200 fixes, to the holding unit 110, both of the main body 41 and the pouring portion 42 by using the package fixing unit 113 of FIG. 4B and FIG. 5B in combination. In this case, the package fixing unit 113 can fix the package 40 more stably.

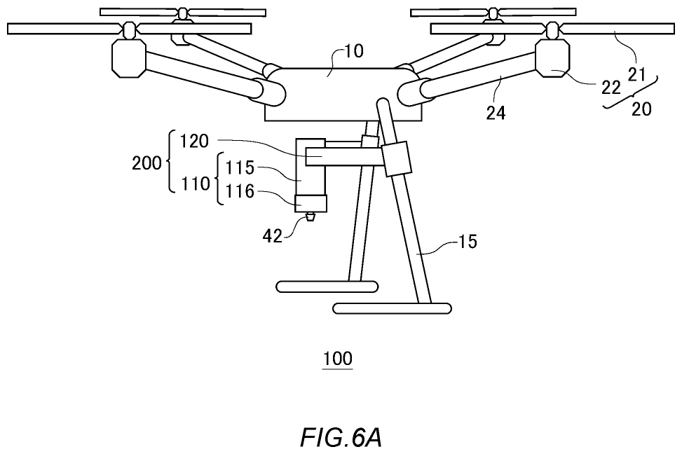

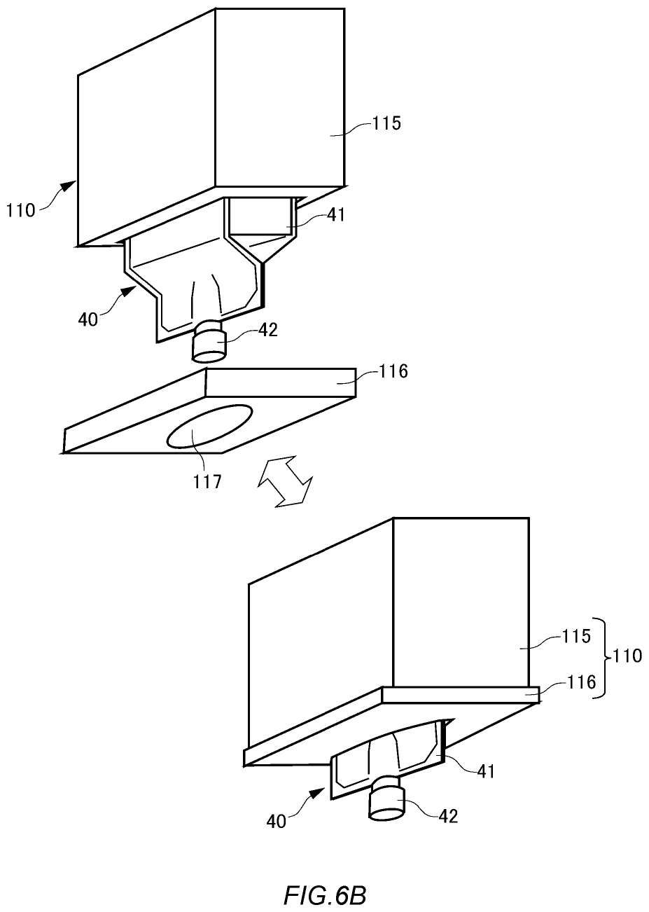

FIG. 6A shows an example of the configuration of the unmanned aerial vehicle 100. The holding unit 110 of the present example has a housing unit 115 and a lid unit 116. The holding member 200 of the present example holds the package 40 in a vertical orientation.

The expression of holding in the vertical orientation refers to a case where a longitudinal direction of the package 40 is the vertical direction. For example, the pouring portion 42 is provided to pour out the content 46 downward in the vertical direction. The holding member 200 of the present example is configured to hold the package 40 such that a shrinkage direction of the package 40 is the horizontal direction when the package 40 is used. It should be noted that the vertical direction and the horizontal direction have been used for the description in the present specification; however, these are merely examples for describing the direction, and an orientation in any direction according to the posture of the unmanned aerial vehicle 100 may be used.

The housing unit 115 houses the package 40. The housing unit 115 only needs to house at least a part of the package 40. That is, a part of the package 40 may be exposed to an outside of the housing unit 115 without being housed, or may be completely housed. As a material of the housing unit 115, metal such as aluminum, or a material with high rigidity such as carbon fiber may be used. In addition, a cushioning material for protecting the package 40 may be further provided inside the housing unit 115. The package 40 is protected by the housing unit 115, and thus safety is high. The posture of the housing unit 115 may be changed by the posture change unit 130.

The lid unit 116 is a lid of the housing unit 115 housing the package 40. The lid unit 116 is attached after the package 40 has been housed in the housing unit 115. The lid unit 116 may have an opening for exposing the pouring portion 42 to the outside of the housing unit 115, or the lid unit 116 may fix the pouring portion 42 as in the configuration of FIG. 4B.

FIG. 6B shows an example of a method for replacing the package 40. In the present example, in the unmanned aerial vehicle 100 of FIG. 6A, a case where the package 40 is replaced will be described.

The housing unit 115 has an inner wall, in which a space for holding the package 40 is formed. The inner wall of the housing unit 115 has a shape in accordance with the package 40. The housing unit 115 of the present example has the inner wall corresponding to one package 40, and holds the package 40. The housing unit 115 may cause the package 40 with a structure, which is unable to be self-supporting, to be self-supporting by the inner wall. The housing unit 115 may have the inner wall corresponding to the plurality of packages 40. The housing unit 115 may have a plurality of spaces corresponding to the packages 40. It should be noted that the housing unit 115 may have a mechanism for pushing out the content 46 by sandwiching the package 40.

The lid unit 116 has an opening 117 for exposing the pouring portion 42. The opening 117 is provided such that the package 40 does not fall out from the holding unit 110. The lid unit 116 may be provided with a plurality of openings 117 according to the number of packages 40. The lid unit 116 may adjust a speed of the content 46 that is poured out from the package 40 according to a shape of the opening 117.

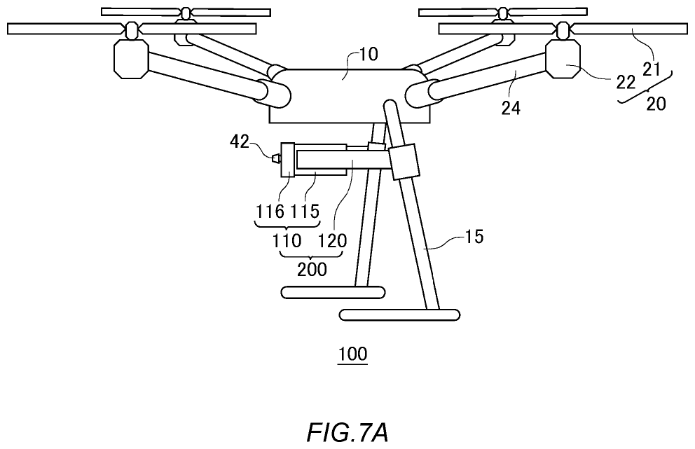

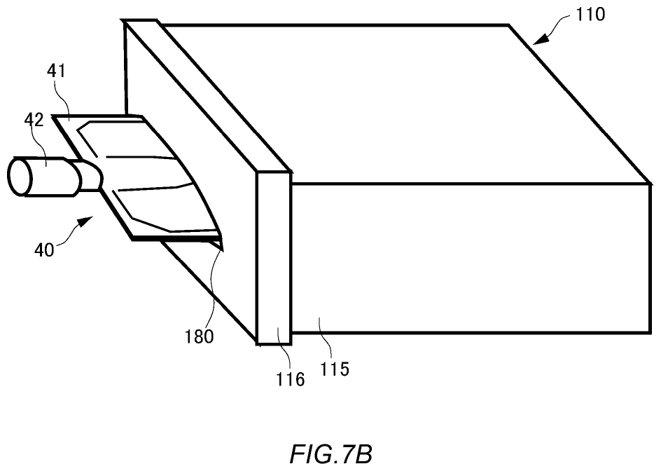

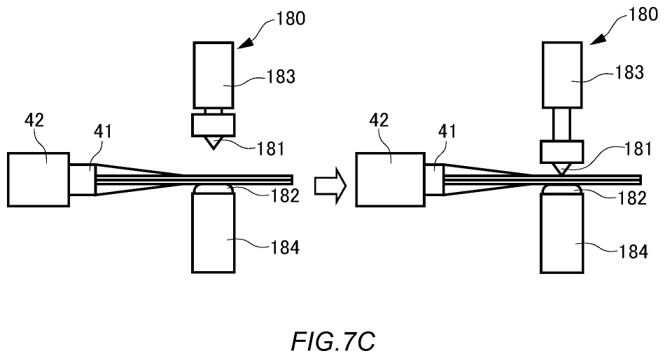

FIG. 7A shows an example of the configuration of the unmanned aerial vehicle 100. In the unmanned aerial vehicle 100 of the present example, an orientation in which the package 40 is held by the holding member 200 is different from the case of FIG. 6A. The holding member 200 of the present example holds the package 40 in a horizontal orientation.

The expression of holding in the horizontal orientation refers to a case where the longitudinal direction of the package 40 is the horizontal direction. For example, the pouring portion 42 is provided to spray the content 46 in the horizontal direction. The holding member 200 of the present example is configured to hold the package 40 such that a shrinkage direction of the package 40 is the vertical direction when the package 40 is used.

FIG. 7B shows an example of a configuration of the holding unit 110. The package 40 of the present example is the pouch type package, and when the longitudinal direction of the package 40 is in a horizontal plane, the width of the package 40 in the vertical direction becomes small. The housing unit 115 may have the mechanism for pushing out the content 46 by sandwiching the package 40. The holding member 200 of the present example has a sealing mechanism 180 configured to seal the package 40.

The sealing mechanism 180 is configured to seal the package 40 according to the remaining amount in the package 40. For example, the sealing mechanism 180 is a heat sealer for sealing the package 40. The sealing mechanism 180 of the present example is provided in the lid unit 116.

The unmanned aerial vehicle 100 of the present example can avoid, by sealing the used package 40 by the sealing mechanism 180, contamination by the content 46 after use. Thereby, the replacement work of the package 40 is easy. It should be noted that the unmanned aerial vehicle 100 may have a mechanism for reopening the package 40 sealed by the sealing mechanism 180.

FIG. 7C shows an example of a specific configuration of a sealing mechanism 180. The sealing mechanism 180 of the present example includes a heating unit 181, a heat resistant unit 182, a drive unit 183, and a support unit 184.

The heating unit 181 is connected to the drive unit 183, and is driven toward a direction in which the heat resistant unit 182 is arranged. The heat resistant unit 182 is supported by the support unit 184, and is provided to sandwich the main body 41 with the heating unit 181. The sealing mechanism 180 seals the main body 41 by sandwiching the main body 41 between the heating unit 181 and the heat resistant unit 182 and heating the main body 41. The main body 41 has a packaging material in which surfaces that come into contact with each other adhere to each other by heating. For example, the main body 41 includes a melted layer that is melted by heating and a non-melting layer that is not melted by heating, and is sealed by melted layers, which are opposite to each other, being melted and adhering to each other. Note that the method for sealing the main body 41 is not limited to the present example.

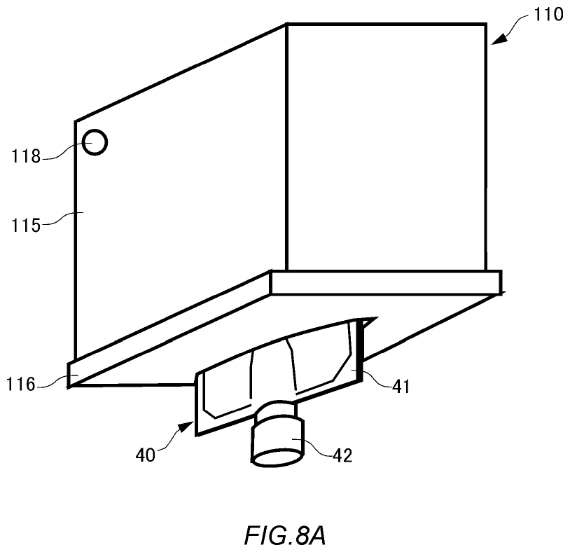

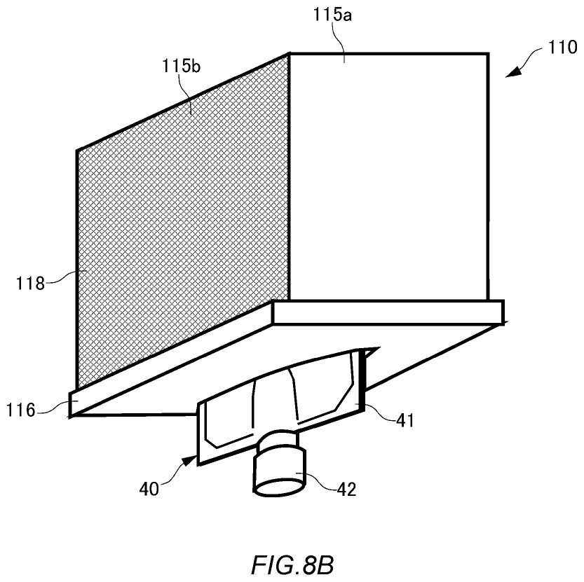

FIG. 8A shows an example of the configuration of the holding unit 110 having an opening 118. The holding member 200 has at least one opening 118 on a surface covering the package 40.

The opening 118 is provided in the housing unit 115. In the present example, one circular opening 118 is provided in the housing unit 115. The shape and the number of openings 118 are not limited to this. The shape of the opening 118 may be any shape such as an ellipse or a polygon. In an example, the opening 118 is one small hole provided in a bottom portion, in the housing unit 115, on a side opposite to the lid unit 116, and functions as an air hole. The opening 118 may function as a window for checking the mounted package 40. The holding unit 110 of the present example can be provided with the opening 118 while maintaining a protective performance for the package 40.

FIG. 8B shows an example of the configuration of the holding unit 110 having the opening 118. The housing unit 115 of the present example includes a housing unit 115a that does not have the opening 118 and a housing unit 115b that has the opening 118.

The housing unit 115a does not have the opening 118, and thus a deterioration of the protective performance of the holding unit 110 can be suppressed. The housing unit 115b has the opening 118, and thus a weight of the holding unit 110 can be reduced. For example, the holding unit 110 is provided with the housing unit 115a on two surfaces opposite to each other, and is provided with the housing unit 115b on the other two surfaces opposite to each other. One side of the holding unit 110 may be set as the housing unit 115b, and the other three surfaces may be set as the housing unit 115a. The holding unit 110 may be appropriately designed according to the protection performance, the weight, or the like of the holding unit 110. In addition, without the holding unit 110 being included, the opening 118 may be provided on the entire surface of the holding unit 110.

The opening 118 has a lightening structure. The opening 118 of the present example is an opening with a shape of a mesh. The housing unit 115b may be formed of the same material as the housing unit 115a, or may be formed of a different material. The opening 118 may have a regular shape such as a honeycomb structure, or may have an irregular shape.

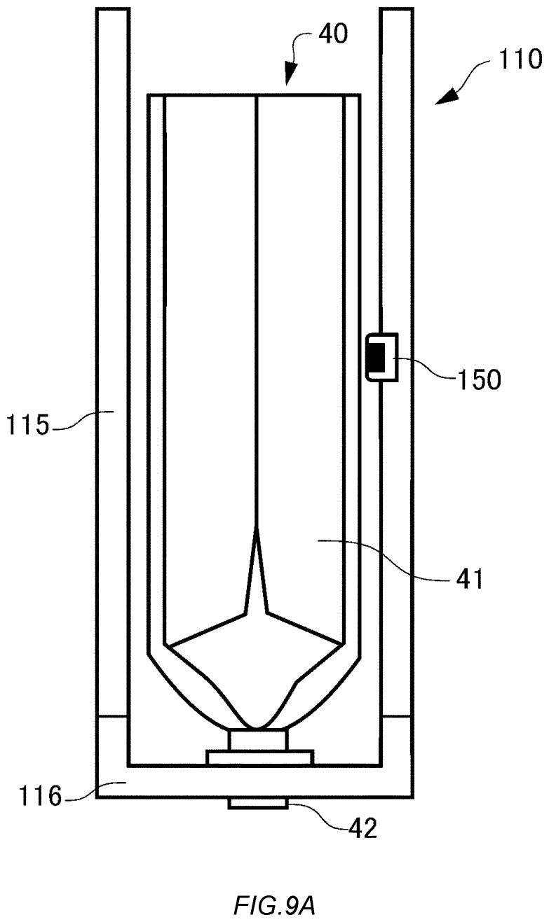

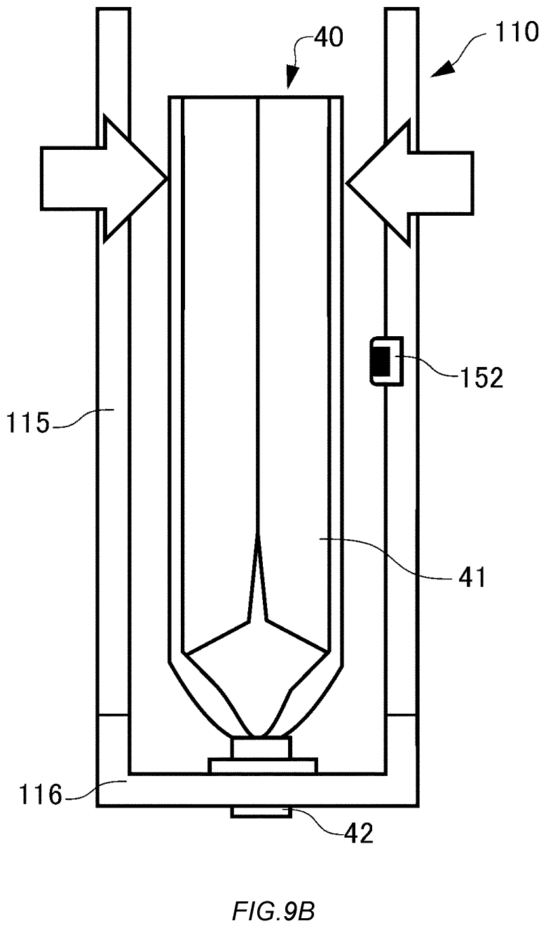

FIG. 9A shows an example of the configuration of the holding unit 110 having a determination unit 150. In the holding unit 110 of the present example, one end of the housing unit 115 is open, but may be closed.

The determination unit 150 is configured to determine whether the package 40 is attached. The determination unit 150 may recognize the package 40 optically, or may recognize the package 40 by weight. In addition, the determination unit 150 may be a pressure sensor on which pressure is imposed by the package 40 being inserted. For example, the determination unit 150 detects a presence of the package 40 by a photo reflector having a light emitting unit, and a light receiving unit that receives light from the light emitting unit. The determination unit 150 of the present example is provided to face a side surface of the package 40, but may be provided to face an upper surface or a lower surface of the package 40. The determination unit 150 is provided in the housing unit 115, but may be provided in another member such as the lid unit 116.

FIG. 9B shows an example of the holding unit 110 having a detection unit 152. The present example shows a state after use of the package 40.

The detection unit 152 is configured to detect the remaining amount of the content 46 of the package 40. In an example, the detection unit 152 detects the remaining amount of the content 46 of the package 40 by detecting the width of the package 40. For example, the detection unit 152 is a sensor that measures a distance from the package 40. The detection unit 152 may be a camera that captures an image of the package 40, or a measurement unit that measures a weight of the package 40. The holding member 200 may have a calculation unit that calculates, from the change in width of the package 40, a used amount or the remaining amount of the content 46. It should be noted that the detection unit 152 may double as the determination unit 150 for the function of determining whether the package 40 is attached.

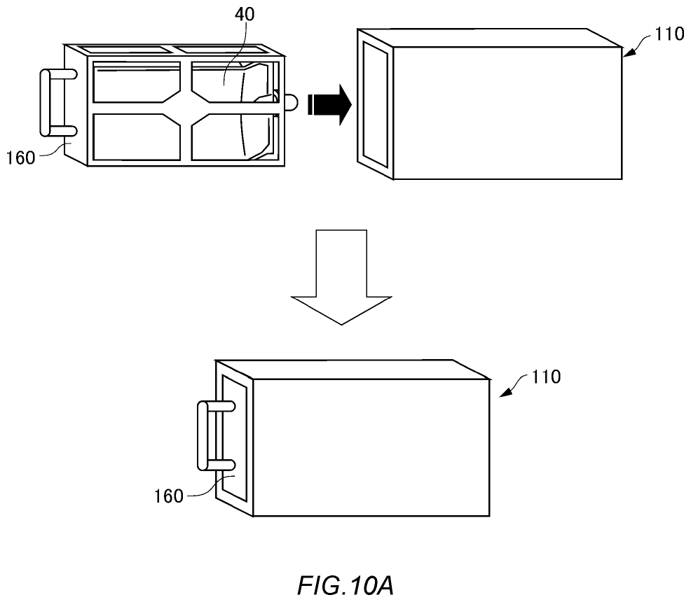

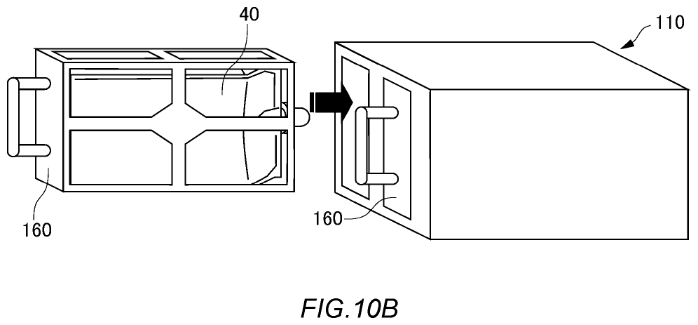

FIG. 10A shows an example of the configuration of a holding unit 110 having a housing member 160. A method for attaching the housing member 160 to the holding unit 110 will be described.

The housing member 160 is configured to house the package 40. The housing member 160 is able to be attached to and detached from the holding unit 110. The housing member 160 functions as a cartridge that is housed in the holding unit 110. The package 40 may or may not be able to be attached to and detached from the housing member 160. That is, the user of the package 40 can assemble, as an advance preparation, the cartridge including the package 40 and the housing member 160, to be filled with the content 46. In addition, the user of the package 40 may purchase the assembled cartridge from the manufacturer, and use the assembled cartridge, the assembled cartridge including the package 40 filled with the content 46, and the housing member 160.

By using the housing member 160, the package 40 can be easily attached to the holding unit 110. The housing member 160 has a shape in accordance with the package 40. That is, replacing the housing member 160 according to the shape of the package 40 makes it possible to use the package 40 with various shapes without replacing the holding unit 110. It should be noted that the housing member 160 of the present example has a lightening structure, but may have a structure to cover a periphery of the package 40.

In the holding member 200 of the present example, in addition to the holding unit 110, the housing member 160 also protects the package 40 from an impact, and thus safety in an event of an accident is further enhanced. By using the housing member 160, even in a case of the package 40 with a large volume, which is difficult to grasp by hand, easy handling is possible. When the housing member 160 is used at a time of replacement, it is not necessary to directly touch the package 40 such that even the used package 40 is less likely to cause contamination.

FIG. 10B shows an example of the configuration of the holding unit 110 having the housing member 160. A method for attaching a plurality of housing members 160 to the holding unit 110 will be described.

The holding unit 110 houses the plurality of housing members 160. The holding unit 110 of the present example houses two housing members 160; however, the number of the housing members 160 is not limited to this.

The plurality of housing members 160 have the same structure. However, the plurality of housing members 160 may have different structures from each other. This makes it possible to house the packages 40 with different shapes. In addition, the plurality of housing members 160 only need to house the packages 40 according to the amount of the necessary content 46. That is, it is not necessary for all of the plurality of housing members 160 to house the packages 40, and some of the housing members 160 may not house the package 40.

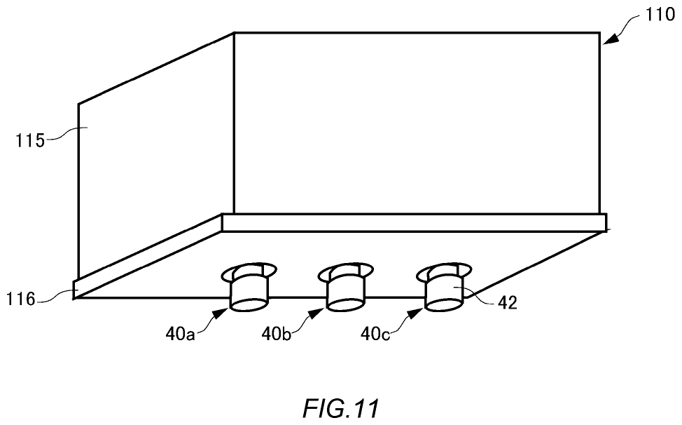

FIG. 11 shows an example of the holding unit 110 that holds a plurality of packages 40. The holding unit 110 of the present example holds total three of package 40a to package 40c.

Volumes of the plurality of packages 40 may be different from each other. The plurality of packages 40 may have contents 46 different from each other. In the present example, the total three of package 40a to package 40c are arranged at equal intervals; however, the number and a method for arranging the packages 40 are not limited to this. The holding unit 110 of the present example holds the plurality of packages 40 in the vertical orientation, but may stack the plurality of packages 40 flat.

It should be noted that the holding unit 110 of the present example may be appropriately used in combination with a technology of another example That is, the holding unit 110 may include the opening 118 shown in FIG. 8A or FIG. 8B. The holding unit 110 may be provided with the sealing mechanism 180 for each of the plurality of packages 40. The holding unit 110 may seal the package 40 with a low remaining amount, or may seal the package 40 that is no longer used. The holding unit 110 may be provided with the determination unit 150 or the detection unit 152 for each of the plurality of packages 40. The holding unit 110 may be housed by the housing member 160.

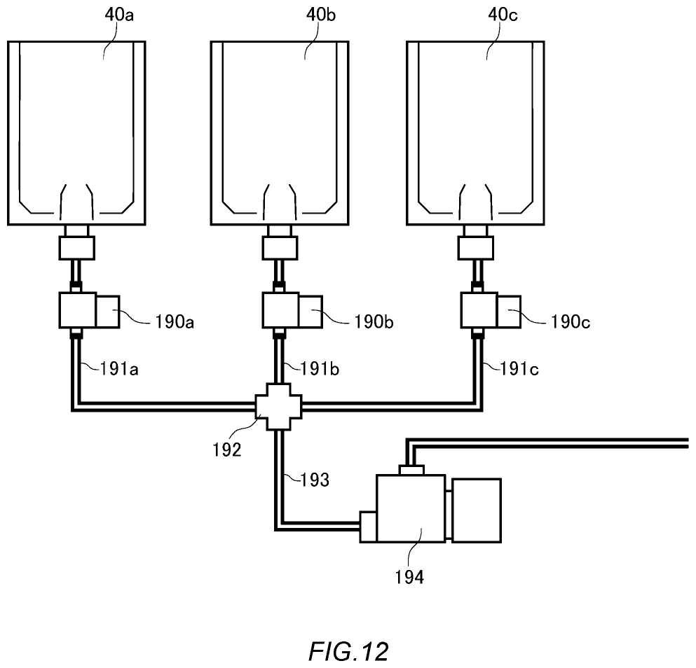

FIG. 12 shows an example of a method for connecting the plurality of packages 40. The unmanned aerial vehicle 100 of the present example includes a selection unit 190, a connection unit 192, and a supply unit 194. The unmanned aerial vehicle 100 holds the plurality of packages 40 by the holding member 200.

The plurality of packages 40 are connected in parallel. In an example, the plurality of packages 40 have the contents 46 with the same volume and type. Volumes of the plurality of packages 40 may be different from each other. The plurality of packages 40 may have contents 46 different from each other. On the unmanned aerial vehicle 100 of the present example, the total three of package 40a to package 40c are mounted.

The selection unit 190 is configured to select, from among the plurality of packages 40, any package 40 for pouring out the content 46. A plurality of selection units 190 are provided to correspond to the plurality of packages 40. The unmanned aerial vehicle 100 of the present example includes total three of selection unit 190a to selection unit 190c corresponding to the total three of package 40a to package 40c. In an example, the selection unit 190 is a solenoid valve of which opening and closing is able to be controlled. In each of the plurality of selection units 190, the opening and closing of the valve is independently controlled. For example, the unmanned aerial vehicle 100 opens any selection unit 190 selected from among the plurality of selection units 190 and pours out the content 46.

This makes it possible to pour out the content 46 from any package 40. For example, it is possible to spray liquid fertilizers with different concentrations depending on a condition of the agricultural land. In addition, when all the packages 40 have the same content 46, it is possible to use the packages 40 one by one. In this case, the package 40, which is unused, can be stored until next work to be used as is.

An elongation unit 191 is provided to elongate from the selection unit 190 to the connection unit 192. The unmanned aerial vehicle 100 of the present example includes total three of elongation unit 191a to elongation unit 191c corresponding to the selection unit 190a to the selection unit 190c. For example, the elongation unit 191 is a tube for pouring out the content 46. Lengths of the plurality of elongation units 191 may be the same, or different from each other.

The connection unit 192 is connected to the plurality of selection units 190 by a plurality of elongation units 191. For example, the connection unit 192 is a manifold connected to the three selection units 190. The connection unit 192 of the present example is connected to the three elongation units 191 and one elongation unit 193.

The elongation unit 193 is provided to elongate from the connection unit 192 to the supply unit 194. The elongation unit 193 sends, to the supply unit 194, the content 46 from the package 40 selected from among the package 40a to the package 40c.

The supply unit 194 supplies the content 46 from the selected package 40. For example, the supply unit 194 is a pump for supplying the content 46. It should be noted that the entire structure from the package 40 to the supply unit 194 may be held by the holding member 200, or a part of the structure may be provided on an outside.

In the unmanned aerial vehicle 100 of the present example, the packages 40 are mounted in small pieces. The packages 40 in small pieces make it easy to be mounted even in a case of a large volume. In addition, the packages 40 in small pieces make it possible to suppress the fluctuation of the content 46 inside the package 40.

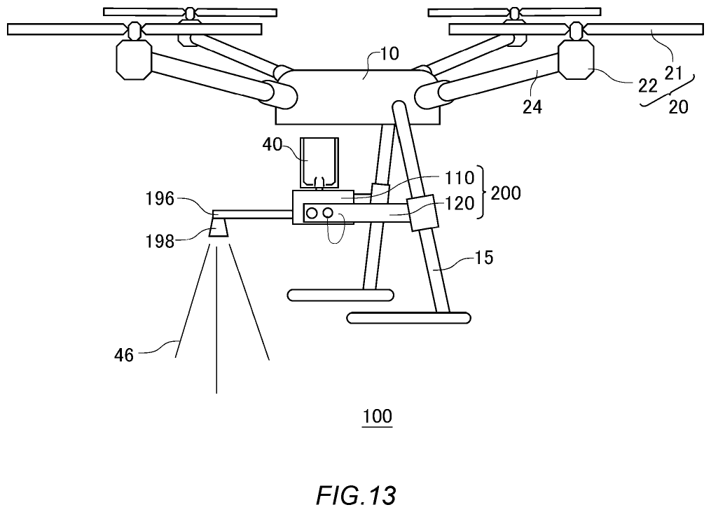

FIG. 13 shows an example of a spraying method by using the unmanned aerial vehicle 100. The holding member 200 of the present example includes an extension unit 196 and a nozzle 198. In the unmanned aerial vehicle 100 of the present example, the content 46 is sprayed in a state in which the package 40 is held by the holding member 200.

The extension unit 196 is connected to the pouring portion 42. The extension unit 196 is used to extend to any position to pour out the content 46. By providing the extension unit 196, it is possible to prevent the contamination of the unmanned aerial vehicle 100.

The nozzle 198 sprays the content 46. The nozzle 198 is provided at a tip of the extension unit 196. When the content 46 is a liquid, the nozzle 198 may diffuse and spray the content 46. The unmanned aerial vehicle 100 of the present example includes one nozzle 198, but may include a plurality of nozzles 198. The unmanned aerial vehicle 100 may differently use the plurality of nozzles 198 respectively for the contents 46.

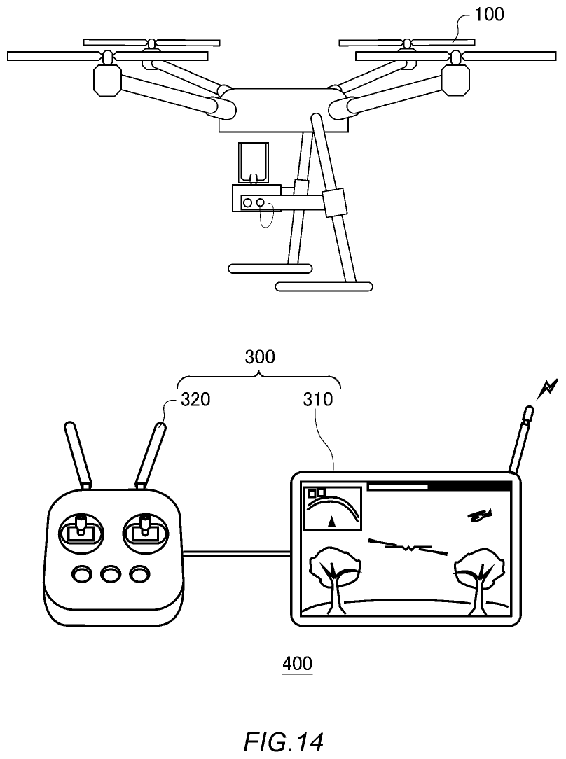

FIG. 14 shows an example of a steering system 400 of the unmanned aerial vehicle 100. The steering system 400 of the present example includes the unmanned aerial vehicle 100 and a terminal device 300. The terminal device 300 includes a display unit 310 and a controller 320.

The display unit 310 displays the video captured by the camera mounted on the unmanned aerial vehicle 100. When the unmanned aerial vehicle 100 includes the fixed camera and the movable camera, the display unit 310 may display the video captured by each camera. For example, the display unit 310 displays the videos captured by the fixed camera and the movable camera on a divided screen. The display unit 310 may directly communicate with the unmanned aerial vehicle 100, or may indirectly communicate with the unmanned aerial vehicle 100 via the controller 320. The display unit 310 may be connected to an external server.

The controller 320 is operated by the user to steer the unmanned aerial vehicle 100. The controller 320 may give an instruction of spraying the content 46, in addition to the flight of the unmanned aerial vehicle 100. The controller 320 may be connected to the display unit 310 in a wired or wireless manner. A plurality of controllers 320 may be provided to be used differently for the steering of the unmanned aerial vehicle 100, and for the spraying control of the content 46.

It should be noted that the unmanned aerial vehicle 100 of the present example is manually operated by using the terminal device 300. Note that the unmanned aerial vehicle 100 may be automatically operated by a program rather than manually. In addition, the user may directly see and steer the unmanned aerial vehicle 100 without using the screen displayed on the display unit 310. In addition, while the steering of the unmanned aerial vehicle 100 is automatically controlled, the spraying of the content 46 may be manually operated.

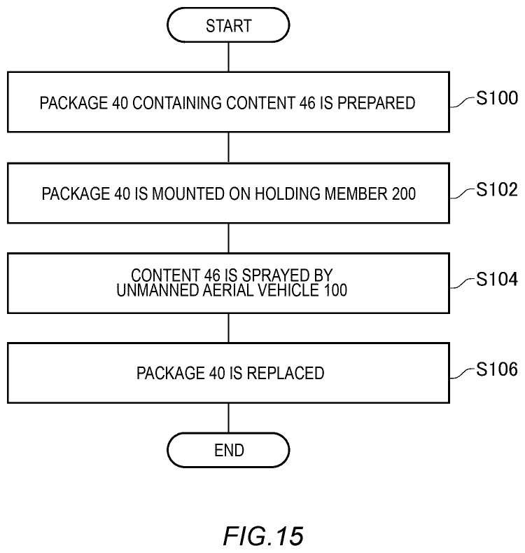

FIG. 15 shows an example of an operation flowchart of a method for spraying a content 46. The unmanned aerial vehicle 100 of the present example sprays the content 46 by step S100 to step S106.

In step S100, the package 40 containing the content 46 is prepared. In step S102, the package 40 is mounted on the holding member 200. The package 40 may be mounted on the holding member 200 by using the housing member 160.

In step S104, the content 46 is sprayed by the unmanned aerial vehicle 100. In step S106, the package 40 is replaced. For example, the unmanned aerial vehicle 100 determines a replacement timing of the package 40 by detecting the remaining amount of the content 46 by the detection unit 152. It should be noted that the package 40 may be disposable, or may be reused by being filled with the content 46.

In the method for spraying the content 46 of the present example, even when there is no remaining amount of the content 46, the replacement with the new package 40 is easily possible. In addition, the content 46 is contained in the package 40, and thus the content 46 is less likely to adhere to a human body and the safety is high at the time of the replacement.

While the embodiments of the present invention have been described, the technical scope of the invention is not limited to the above-described embodiments. It is apparent to persons skilled in the art that various alterations and improvements can be added to the above-described embodiments. It is also apparent from the scope of the claims that the embodiments added with such alterations or improvements can be included in the technical scope of the invention.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the process must be performed in this order.

### EXPLANATION OF REFERENCES

10: main body unit, 15: leg unit, 20: propulsion unit, 21: rotor wing, 22: rotation drive unit, 24: arm unit, 40: package, 41: main body, 42: pouring portion, 44: fixing target portion, 46: content, 100: unmanned aerial vehicle, 110: holding unit, 111: main body, 112: opening, 113: package fixing unit, 114: pouring out unit, 115: housing unit, 116: lid unit, 117: opening, 118: opening, 120: connection unit, 130: posture change unit, 132: posture fixing unit, 150: determination unit, 152: detection unit, 160: housing member, 180: sealing mechanism, 181: heating unit, 182: heat resistant unit, 183: drive unit, 184: support unit, 190: selection unit, 191: elongation unit, 192: connection unit, 193: elongation unit, 194: supply unit, 196: extension unit, 198: nozzle, 200: holding member, 300: terminal device, 310: display unit, 320: controller, 400: steering system

1. A holding member comprising:
a holding unit configured to hold a package with a variable volume; and
a connection unit configured to connect the holding unit and an unmanned aerial vehicle.

2. The holding member according to claim 1, comprising:
a posture change unit configured to change a posture of the holding member; and
a posture fixing unit for the holding unit.

3. The holding member according to claim 1, comprising:
a package fixing unit configured to fix the package to the holding unit.

4. The holding member according to claim 3, wherein
the package fixing unit is configured to fix, to the holding unit, a pouring portion for pouring in or pouring out a content of the package.

5. The holding member according to claim 3, wherein
the package fixing unit is configured to fix, to the holding unit, a fixing target portion of the package.

6. The holding member according to claim 3, wherein
the package fixing unit is configured to fix, to the holding unit, a main body of the package.

7. The holding member according to claim 1, the holding member being configured to hold the package such that a shrinkage direction of the package is a horizontal direction or a vertical direction when the package is used.

8. The holding member according to claim 1, the holding member being provided with at least one opening on a surface covering the package.

9. The holding member according to claim 1, comprising:
a determination unit configured to determine whether the package is attached.

10. The holding member according to claim 1, comprising:
a housing member configured to house the package, wherein
the housing member is able to be attached to and detached from the holding member.

11. The holding member according to claim 10, comprising:
a plurality of the housing members, wherein
the plurality of housing members are configured to house one or more packages, respectively,
the holding member being configured to hold the plurality of housing members.

12. The holding member according to claim 1, the holding member being configured to hold a plurality of the packages, wherein
the plurality of packages are connected in parallel,
the holding member comprising a selection unit configured to select, from among the plurality of packages, any package for pouring out a content.

13. The holding member according to claim 1, comprising:
a sealing mechanism configured to seal the package.

14. The holding member according to claim 13, comprising:
a detection unit configured to detect a remaining amount in the package, wherein
the sealing mechanism is configured to seal the package according to the remaining amount in the package.

15. The holding member according to claim 1, wherein
the package is a bag made of resin.

16. An unmanned aerial vehicle on which a holding member is mounted, the holding member including:
a holding unit configured to hold a package with a variable volume; and
a connection unit configured to connect the holding unit and the unmanned aerial vehicle.

17. A spraying method wherein
in a state in which a holding member holds a package, and the holding member holding the package is mounted on an unmanned aerial vehicle, a content of the package is sprayed from the unmanned aerial vehicle; and
the holding member includes:
a holding unit configured to hold the package with a variable volume; and
a connection unit configured to connect the holding unit and the unmanned aerial vehicle.

18. The holding member according to claim 2, comprising:
a package fixing unit configured to fix the package to the holding unit.

19. The holding member according to claim 2, comprising:
a determination unit configured to determine whether the package is attached.

20. The holding member according to claim 2, comprising:
a housing member configured to house the package, wherein
the housing member is able to be attached to and detached from the holding member.
